(19) United States
(12) Patent Application Publication
(10) Pub. No.: US 2026/0301056 A1
(43) Pub. Date: Oct. 1, 2026

(54) Machine Learning System for Predicting an Impact of Incomplete Deliveries and Initiating Automated Error-Reduction Measures Based on Same

(71) Applicant: Maplebear Inc., San Francisco, CA (US)

(72) Inventors: Shang Li, Short Hills, NJ (US); Sandrine Meunier, Bellevue, WA (US); Richard Shafer, San Francisco, CA (US); Renfei Yu, Toronto (CA); Ali Shameli, Irvine, CA (US); Alan Hwang, San Francisco, CA (US)

(21) Appl. No.: 19/094,507

(22) Filed: Mar. 28, 2025

(51) Int. Cl. G06Q 30/0601

(52) U.S. Cl. CPC G06Q 30/0635

(57) ABSTRACT

An online system receives an order including one or more items from a user and detects that a picker servicing the order has collected the items. The system retrieves inputs including picker data indicating a skill level associated with the picker, user data indicating a tendency of the user to raise an order issue, and item data for each item. The system accesses and applies a machine learning model to predict, based on the inputs, a value of a metric associated with each item if the item is missing when the order is delivered. The system determines to invoke one or more preventative measures to avoid delivering the order with a missing item based on the predicted value of the metric associated with each item and sends a signal to a client device associated with the picker, causing it to display information describing the preventative measures.

### BACKGROUND

Online systems may allow their users to place orders that are serviced on their behalf by pickers (e.g., by driving to source locations, collecting items included in the orders, and delivering the orders to the users who placed the orders). When delivered, an order may be missing an item for various reasons (e.g., if the item falls out of a bag, if a picker forgets to collect the item, etc.). Furthermore, although pickers often service multiple orders at the same time to be more efficient, doing so also increases the likelihood that items are missing from the orders when delivered (e.g., if an item included in one order is misplaced in a bag for a different order, if bags of items included in different orders are mixed up, etc.). Online systems may invoke various preventative measures to avoid delivering orders with missing items. For example, an online system may require a picker to scan a barcode coupled to each item included in each order they are servicing to ensure that no items are missing and to organize bags containing the items in a particular way (e.g., to indicate whether they include items in the same order and to prevent the items from rolling or falling out of the bags). In this example, the online system also may require the picker to capture an image of the organized bags.

Although invoking such preventative measures may help to avoid delivering orders with missing items, doing so may also decrease the efficiency with which the orders are serviced. In the above example, suppose that the picker is very experienced at servicing orders and rarely delivers orders with missing items, and that the picker is servicing two orders, each of which includes only a single item, such that the picker is unlikely to deliver the orders with missing items. In this example, invoking the preventative measures might not decrease the likelihood that an item is missing from an order when delivered and may cause delivery of the orders to be delayed (e.g., if an item is missing a barcode, if a camera used by the picker to capture the image is malfunctioning, etc.).

Effectively balancing the need for preventative measures with the efficiency of the fulfillment process presents a technical challenge. Existing rule-based approaches may apply blanket requirements that fail to account for factors such as a picker’s historical accuracy, the complexity of an order, or the likelihood of specific errors occurring. As a result, unnecessary verification steps may be triggered, leading to inefficiencies, or critical checks may be skipped, increasing the risk of missing items. Addressing this challenge requires a more adaptive and data-driven approach that dynamically determines when and how preventative measures should be applied.

### SUMMARY

In accordance with one or more aspects of the disclosure, an online system invokes a set of preventative measures to avoid delivering an order with a missing item. More specifically, an online system receives an order including one or more items from a user client device associated with a user and detects that a picker servicing the order has collected the items from a source location. The online system then retrieves a set of inputs for a machine learning model trained to predict a value of a metric associated with an item included in the order if the item is missing when the order is delivered to the user, in which the set of inputs includes a set of picker data indicating a skill level associated with the picker, a set of user data indicating a tendency of the user to raise an order issue, and a set of item data for each item. The online system accesses and applies the machine learning model to predict the value of the metric associated with each item based on the set of inputs. The online system then determines to invoke a set of preventative measures to avoid delivering the order with one or more missing items based on the predicted value of the metric associated with each item and sends a signal to a picker client device associated with the picker, causing the picker client device to display information describing the set of preventative measures. In one or more embodiments, the online system generates a fulfillment reliability score indicating a reliability of order fulfillment by the picker based on the predicted value of the metric associated with each item. In such embodiments, the online system may use the fulfillment reliability score for various purposes, such as providing access to different kinds of orders based on the fulfillment reliability scores, such as more complicated orders.

Thus, based on the predicted value of the metric associated with each item (e.g., whether the predicted value is greater than a threshold value), the online system may or may not invoke the set of preventative measures, thereby improving the efficiency with which orders may be serviced. Furthermore, by taking into account picker data for the picker, user data for the user, and item data for each item, the predicted value of the metric associated with each item is specific to the order, improving its reliability when determining whether to invoke the set of preventative measures. Additionally, by taking into account the predicted value of the metric associated with each item to generate the fulfillment reliability score, the fulfillment reliability score is normalized to account for differences between orders serviced by the picker, such as different rates at which different users raise order issues, order complexity, etc.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for determining to invoke a set of preventative measures to avoid delivering an order with a missing item, in accordance with one or more embodiments.

FIG. 4A illustrates an example process for determining to invoke a set of preventative measures to avoid delivering an order with a missing item based on a predicted value of a metric associated with each item included in the order, in accordance with one or more embodiments.

FIG. 4B illustrates an example process for determining to invoke a set of preventative measures to avoid delivering an order with a missing item based on a composite value associated with items included in the order, in accordance with one or more embodiments.

FIG. 5 illustrates an example process for generating a fulfillment reliability score associated with a picker, in accordance with one or more embodiments.

### DETAILED DESCRIPTION

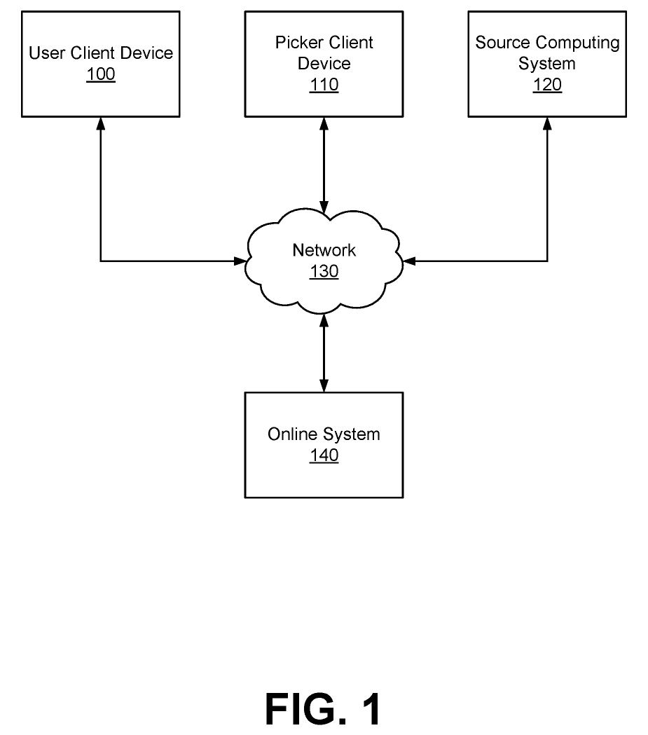

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more source locations from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user’s order to the picker in a collection interface. The collection interface is a user interface that provides information to the picker identifying items to collect for a user’s order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

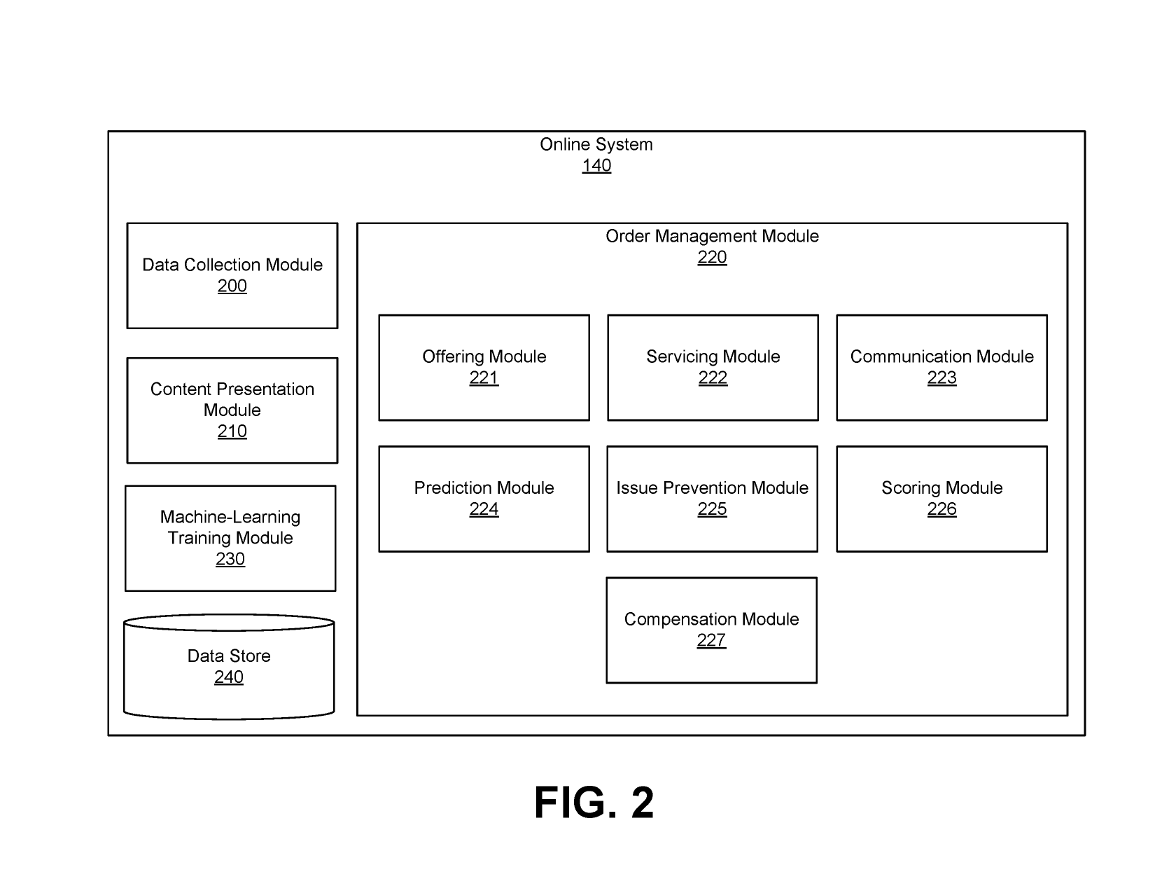

As an example, the online system 140 may allow a user to order groceries from a grocery store source. The user’s order may specify which groceries they want to be delivered from the grocery store source and the quantities of each of the groceries. The user’s client device 100 transmits the user’s order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140. The online system 140 is described in further detail below with regard to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user’s name, address, preferences, (e.g., shopping or dietary preferences, favorite items, sources, source locations, recipes, or cuisines, etc.), dietary restrictions, or stored payment instruments. User data also may include demographic information associated with a user (e.g., age, gender, geographical region, etc.) or household information associated with the user (e.g., a number of people in the user’s household, whether the user’s household includes children or pets, etc.). The user data also may include default settings established by the user, such as a default source/source location, payment instrument, delivery location, or delivery timeframe.

User data also may include information associated with orders placed by a user. Examples of such types of information include: order data for orders placed by the user, item data for each item included in each order placed by the user, or any other suitable types of information. For example, user data for a user may include information describing an order placed by the user, such as a date and a time the order was placed and information describing the user, a picker who serviced the order, each item included in the order, a source location from which one or more items included in the order were collected, etc. In this example, if the user raised an order issue by indicating an item was missing from the order (e.g., the item was not included in the order or a wrong version of the item was collected), the user data also may include information describing the order issue (e.g., the type of order issue, one or more items associated with the order issue, etc.) and an appeasement offered to the user due to the order issue (e.g., a refund for the missing item). In some embodiments, the user data may indicate a tendency of the user to raise an order issue. For example, user data may describe a frequency with which a user raises a type of order issue. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, shape, color, weight, stock keeping unit (SKU), serial number, price, item category, brand, quality (e.g., freshness, ripeness, etc.), ingredients/materials, manufacturing location, version/variety (e.g., flavor, low fat, gluten-free, organic, vegetarian, etc.) of an item. Item data also may include images or videos of items, descriptions of items, or any other suitable types of information that may describe or identify items. Item data also may include historical order information associated with an item, such as a frequency with which the item is associated with a type of order issue (e.g., missing item, mishandled item, etc.). The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker’s name, the picker’s location, how often the picker has serviced orders for the online system 140, the source locations from which the picker has collected items, etc. Picker data also may include demographic information associated with a picker (e.g., age, gender, geographical region, etc.). In some embodiments, the picker data may indicate a skill level associated with a picker. For example, picker data may include a user rating for a picker or the picker’s shopping history describing a number of orders or batches of orders the picker has serviced (e.g., by collecting items included in the orders, by delivering the orders, etc.). Additionally, the picker data may include preferences expressed by the picker, such as their preferred source locations for collecting items, how far they are willing to travel to deliver items to a user, how many items they are willing to collect at a time, timeframes within which the picker is willing to service orders, or payment information by which the picker is to be paid for servicing orders (e.g., a bank account). The picker data also may include a fulfillment reliability score indicating a reliability of order fulfillment by a picker. For example, the fulfillment reliability score may correspond to a value from negative one to positive one, in which a positive fulfillment reliability score indicates a higher reliability of order fulfillment than a negative fulfillment reliability score. The fulfillment reliability score may be normalized to account for differences between orders serviced by the picker, such as different rates at which different users raise order issues, order complexity (e.g., a number of items included in each order or whether each order includes instructions specified by a user), etc. The data collection module 200 collects picker data from sensors of the picker client device 110, from the picker’s interactions with the online system 140, or from other components of the online system 140.

Additionally, the data collection module 200 collects order data, which is information or data describing characteristics of an order. For example, order data may include item data for items that are included in an order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data include user data for users associated with the order, such as user data for a user who placed the order or picker data for a picker who serviced the order. Order data also may include information describing a set of order issues associated with an order raised by a user. Examples of order issues include: missing items (e.g., failure to collect an item or a correct version/variety of an item), mishandled items (e.g., if heavy items are placed on top of fragile items), damaged items (e.g., if items are crushed or broken), failure to follow instructions (e.g., for collecting items included in the order or for delivering the order), late delivery (i.e., after a delivery timeframe for the order), etc. Furthermore, order data may indicate a tendency of items ordered from a source or collected from a source location to be associated with a type of order issue. For example, a set of order data may describe a frequency with which items ordered from a source or collected from a source location are missing from delivered orders. Order data further may include information describing a set of preventative measures invoked to avoid an order issue. The data collection module 200 collects order data from a source computing system 120, a picker client device 110, or a user client device 100.

The data collection module 200 also may collect preventative measure data, which is information or data describing characteristics of a preventative measure that may be invoked to avoid delivering an order with an order issue. Examples of preventative measures include: scanning (e.g., using an image capture device and/or application executing on picker device 110) a machine-readable label (e.g., a barcode or a QR code) coupled to an item that encodes an item identifier for the item or capturing (e.g., using an image capture device of picker device 110) an image or a video of an item and identifying an item identifier for the item based on the image/video (e.g., using a picker client device 110 or by transmitting the image/video to the online system 140). Additional examples of preventative measures include: organizing one or more items (e.g., in bags or other containers to indicate whether they are included in the same order or to prevent the items from rolling or falling out of the bags/containers), capturing an image/video of the organized items (e.g., using image capture device of picker device 110), and transmitting the image/video to the online system 140. Preventative measure data may include a cost (e.g., a dollar amount) assumed by the online system 140 if a preventative measure is invoked. The cost may be based on an amount of resources (e.g., time or computing resources), payment (e.g., to a picker), etc. required to invoke the preventative measure. For example, preventative measure data may indicate that organizing items in a bag to prevent the items from rolling out may be associated with a lower cost than scanning a barcode coupled to each item since the former takes less time to be performed by a picker servicing the order than the latter. Furthermore, preventative measure data may describe a type of order issue that a preventative measure may prevent. For example, preventative measure data may indicate that capturing an image of an item and identifying an item identifier for the item based on the image may prevent items from being missing or damaged, while organizing items to indicate whether they are included in the same order, capturing an image of the organized items, and transmitting the image to the online system 140 may prevent items included in different orders from being mixed up.

The data collection module 200 also may derive various types of information based on other data stored in the data store 240 and store the derived information in the data store 240 (e.g., in association with the data from which it was derived). For example, based on order data associated with a user, the data collection module 200 may derive a frequency with which the user raises an order issue corresponding to missing items. In this example, based on the order data, the data collection module 200 also may derive an average price of the missing items. As an additional example, based on order data associated with a picker, the data collection module 200 may derive a frequency with which the picker services orders associated with an order issue corresponding to missing items. In this example, based on the order data, the data collection module 200 also may derive an average price of the missing items. As another example, based on order data stored in the data store 240, the data collection module 200 may derive a frequency with which items ordered from a source or collected from a source location are associated with a type of order issue corresponding to damaged items.

While user data, picker data, item data, order data, and preventative measure data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. In this example, the content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the user client device 100. A search query is free text for a word or a set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. Components of the order management module 220 include: an offering module 221, a servicing module 222, a communication module 223, a prediction module 224, an issue prevention module 225, a scoring module 226, and a compensation module 227, which are further described below.

The offering module 221 receives orders from user client devices 100 and offers the orders to pickers for service based on picker data. For example, the offering module 221 offers an order to a picker via a picker client device 110 associated with the picker based on the picker’s location, the source location from which the ordered items are to be collected, and a fulfillment reliability score for the picker. The offering module 221 may also offer an order to a picker based on how many items are in the order, a vehicle operated by the picker, the delivery location, the picker’s preferences for how far to travel to deliver an order, the picker’s ratings by users, or how often the picker agrees to service an order.

In some embodiments, the offering module 221 determines when to offer an order to a picker based on a delivery timeframe requested by the user who placed the order. The offering module 221 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the offering module 221 receives an order, the offering module 221 may delay offering the order to a picker if the requested timeframe is far enough in the future (i.e., the picker may be offered the order at a later time and is still predicted to meet the requested timeframe).

When the offering module 221 offers an order to a picker, the servicing module 222 transmits the order to the picker client device 110 associated with the picker. For example, the servicing module 222 may send details about an order (e.g., information describing a number of items included in the order, information identifying the items, information identifying a source location from which the items are to be collected, etc.) to the picker client device 110. The servicing module 222 may also transmit navigation instructions from the picker’s current location to the source location associated with the order. If the order includes items to collect from multiple source locations, the servicing module 222 identifies the source locations to the picker and may also specify a sequence in which the picker should visit the source locations. Once the order is transmitted to the picker client device 110 associated with the picker, the offering module 221 may receive an acceptance of the offer to service the order from the picker via the picker client device 110.

The servicing module 222 may track the location of the picker through the picker client device 110 to determine when the picker arrives at the source location. When the picker arrives at the source location, the servicing module 222 transmits the order to the picker client device 110 for display to the picker. As the picker uses the picker client device 110 to collect items at the source location, the servicing module 222 receives item identifiers for items that the picker has collected for the order. In some embodiments, the servicing module 222 receives images of items from the picker client device 110 and applies computer vision techniques to the images to identify the items depicted by the images. The servicing module 222 may track the progress of the picker as the picker collects items for an order and may transmit progress updates to the user client device 100 that describe which items have been collected for the user’s order.

In some embodiments, the servicing module 222 tracks the location of the picker within the source location. The servicing module 222 uses sensor data from the picker client device 110 or from sensors in the source location to determine the location of the picker in the source location. The servicing module 222 may transmit, to the picker client device 110, instructions to display a map of the source location indicating where in the source location the picker is located. Additionally, the servicing module 222 may instruct the picker client device 110 to display the locations of items for the picker to collect, and may further display navigation instructions indicating how the picker may travel from their current location to the location of the next item to collect for an order.

The servicing module 222 determines when the picker has collected the items for an order. For example, the servicing module 222 may receive a message from the picker client device 110 indicating that all of the items for an order have been collected. Alternatively, the servicing module 222 may receive item identifiers for items collected by the picker and determine when all of the items in an order have been collected. When the servicing module 222 determines that the picker has completed an order, the servicing module 222 transmits the delivery location for the order to the picker client device 110. The servicing module 222 may also transmit navigation instructions to the picker client device 110 that specify how to travel from the source location to the delivery location, or to a subsequent source location for further item collection. The servicing module 222 tracks the location of the picker as the picker travels to the delivery location for an order, and updates the user with the location of the picker so that the user can track the progress of the order. In some embodiments, the servicing module 222 computes an estimated time of arrival of the picker at the delivery location and provides the estimated time of arrival to the user.

In some embodiments, the communication module 223 facilitates communication between the user client device 100 and the picker client device 110. As noted above, a user may use a user client device 100 to send a message to the picker client device 110. The communication module 223 receives the message from the user client device 100 and transmits the message to the picker client device 110 for presentation to the picker. The picker may use the picker client device 110 to send a message to the user client device 100 in a similar manner.

Additionally, the communication module 223 may receive information describing an order issue raised by a user. The communication module 223 may receive the information from a user client device 100 associated with the user. For example, once an order is delivered to a user, the communication module 223 may receive information from a user client device 100 associated with the user indicating that an item is missing from the order. Once the communication module 223 receives the information describing the order issue, the communication module 223 may store the information in the data store 240 (e.g., in association with order data for the order, item data for an item associated with the order issue, user data for the user, picker data for a picker who serviced the order, etc.).

The communication module 223 also may send a signal to a picker client device 110 associated with a picker servicing an order, causing the picker client device 110 to display information describing a set of preventative measures to avoid delivering the order with an order issue (e.g., a missing, mishandled, or damaged item, failure to follow instructions for collecting an item, etc.). The communication module 223 may send the signal via a push notification, a text message, an email, or any other suitable means. The communication module 223 may do so once the issue prevention module 225 determines to invoke the set of preventative measures, as described below.

In some embodiments, the communication module 223 also sends a prompt to a user client device 100 associated with a user who has placed an order. The prompt may be for a response from the user indicating whether one or more items included in the order are associated with an order issue. For example, the communication module 223 may send a prompt to a user client device 100 associated with a user for a response indicating whether the user received an item included in an order placed by the user. The communication module 223 may send the prompt via a push notification, a text message, an email, or any other suitable means. The communication module 223 may do so once the servicing module 222 detects that the order has been delivered to the user.

The prediction module 224 retrieves various types of data from the data store 240. The prediction module 224 may do so once the servicing module 222 detects that a picker servicing an order has collected the items included in the order. Examples of types of data the prediction module 224 may retrieve include: a set of picker data for the picker, a set of user data for a user who placed the order, a set of order data for the order, a set of item data for one or more items included in the order, or any other suitable types of information. In some embodiments, one or more sets of data retrieved by the prediction module 224 are included among a set of inputs for a machine learning model, as further described below. The set of picker data retrieved by the prediction module 224 may indicate a skill level associated with the picker, such as information describing a user rating for the picker and the picker’s previous shopping history (e.g., a number of orders or batches of orders the picker has serviced). The set of user data retrieved by the prediction module 224 may indicate a tendency of the user to raise an order issue, such as information describing a frequency with which the user indicates items are missing from their orders when delivered (e.g., either because an item was not collected or an incorrect version/variety of an item was collected). The set of order data retrieved by the prediction module 224 may describe one or more items included in the order, a source from which the items was/were ordered, a source location from which the items was/were collected, or a tendency of items ordered from the source or collected from the source location to be associated with a type of order issue. The set of item data retrieved by the prediction module 224 may include information describing a tendency of an item included in the order to be associated with a type of order issue or attributes of the item, such as information describing a size, weight, shape, or price of the item.

The prediction module 224 also may predict a value of an order issue metric associated with an item included in an order if the item is associated with an order issue (e.g., a missing, mishandled, or damaged item, failure to follow instructions for collecting an item, etc.). In some embodiments, the order issue metric is an expected cost (e.g., a dollar amount) assumed by the online system 140 to appease a user who placed the order. In such embodiments, the expected cost may be based on a probability that the item is associated with the order issue and that the user will raise the order issue, as well as an appeasement cost associated with an appeasement offered to the user due to the order issue. The appeasement cost may be a cost of the item (e.g., a price of the item if a refund or a credit is issued for the item), a cost of replacing the item (e.g., a sum of a price of a replacement for the item and an amount paid to a picker to collect and deliver it), or any other suitable cost associated with the appeasement. In other embodiments, the order issue metric is a probability that the item is associated with the order issue and that the user will raise the order issue. In such embodiments, the prediction module 224 may compute the expected cost assumed by the online system 140 to appease the user based on the probability and the appeasement cost (e.g., as a product of the probability and the appeasement cost). The prediction module 224 may predict the value of the order issue metric based on data it retrieves from the data store 240, as described above, or based on any other suitable types of data. Once the prediction module 224 predicts the value of the order issue metric, the prediction module 224 may store the value in the data store 240 (e.g., in association with item data for the item, order data for the order, user data for the user, picker data for a picker servicing the order, etc.).

An expected cost assumed by the online system 140 to appease a user who placed an order if an item included in the order is associated with an order issue also may be based on a long-term value associated with the user, a probability that the user stops placing orders with the online system 140 if the item is associated with the order issue, or any other suitable types of information. For example, the prediction module 224 may computed a first product of a probability that an item included in an order is missing when delivered to a user and that the user will indicate that the item is missing, and an appeasement cost associated with an appeasement offered to the user due to the missing item. In this example, the prediction module 224 may then predict a long-term value associated with the user based on historical order information associated with the user, in which the long-term value is proportional to a frequency with which the user places orders, an average amount the user spends on orders, etc. In the above example, the prediction module 224 also may predict a probability that the user will stop placing orders with the online system 140 if the item is missing when the order is delivered, in which the probability is proportional to a frequency with which the user raises order issues, a price of the item, etc. and inversely proportional to an average rating the user provides for deliveries of orders, etc. Continuing with this example, the prediction module 224 may compute a second product of the long-term value associated with the user and the probability that the user will stop placing orders with the online system 140 if the item is missing when the order is delivered. In the above example, the prediction module 224 may then compute an expected cost assumed by the online system 140 to appease the user if the item is missing when the order is delivered as a sum of the first product and the second product.

The following illustrates an example of how the prediction module 224 may predict a value of an order issue metric associated with an item included in an order if the item is associated with an order issue, in which the value corresponds to a probability that the item is associated with the order issue and that a user who placed the order will raise the order issue. The prediction module 224 may retrieve a set of picker data indicating a skill level associated with a picker servicing the order, such as a user rating for the picker for the last 100 batches of orders serviced by the picker and a number of orders the picker has delivered. In the above example, the prediction module 224 may also retrieve a set of user data indicating a tendency of the user to raise an order issue, such as a frequency with which the user indicated items were missing from their orders in the past three months. In this example, the prediction module 224 may retrieve a set of order data indicating a number of items included in the order, and a set of item data that describes a size, shape, weight, and price of the item. In the above example, the probability predicted by the prediction module 224 may be proportional to the frequency with which the user indicated items were missing from their orders and inversely proportional to the user rating for the picker and the number of orders the picker has delivered. Continuing with the above example, since smaller, lighter, and less expensive items are more likely to be overlooked or lost than larger, heavier, and more expensive items, the probability also may be inversely proportional to the size, weight, and price of the item. In this example, since the item is more likely to be lost if the order includes several items rather than a few items, the probability also may be proportional to the number of items included in the order. Furthermore, in the above example, since the item may be more likely to roll out of a bag or other container used to deliver the item if the shape of the item is round or cylindrical, the probability may be higher if the item is round or cylindrical than if it is not.

In some embodiments, the prediction module 224 predicts a value of an order issue metric associated with an item included in an order if the item is associated with an order issue using an order issue metric prediction model, which is a machine learning model trained to predict the value. To use the order issue metric prediction model, the prediction module 224 may access the model (e.g., from the data store 240) and apply the model to a set of inputs. The set of inputs may include various types of data retrieved by the prediction module 224 described above (e.g., a set of picker data for a picker servicing the order, a set of user data for a user who placed the order, a set of order data for the order, a set of item data for the item, etc.). Once the prediction module 224 applies the order issue metric prediction model to the set of inputs, the prediction module 224 may receive an output from the model, which may include the value of the order issue metric associated with the item included in the order if the item is associated with the order issue. In some embodiments, the order issue metric prediction model is trained by the machine-learning training module 230, as described below.

The issue prevention module 225 determines whether to invoke a set of preventative measures to avoid delivering an order with an order issue (e.g., a missing, mishandled, or damaged item, failure to follow instructions for collecting an item, etc.). As described above, examples of such measures include: scanning a machine-readable label (e.g., a barcode or a QR code) coupled to an item that encodes an item identifier for the item or capturing an image or a video of an item and identifying an item identifier for the item based on the image/video (e.g., using a picker client device 110 or by transmitting the image/video to the online system 140). As also described above, additional examples of preventative measures include: organizing one or more items (e.g., in bags or other containers to indicate whether they are included in the same order or to prevent the items from rolling or falling out of the bags/containers), capturing an image/video of the organized items, and transmitting the image/video to the online system 140. The issue prevention module 225 may determine whether to invoke the set of preventative measures based on an expected cost assumed by the online system 140 to appease a user who placed the order (e.g., whether the expected cost is at least a threshold cost). For example, suppose that for each item included in an order, the prediction module 224 or compute an expected cost assumed by the online system 140 to appease a user who placed the order if the item is associated with an order issue and compares each expected cost to a threshold cost. In this example, if at least a threshold number of items included in the order are associated with an expected cost that is at least the threshold cost, the issue prevention module 225 may determine to invoke one or more preventative measures to avoid delivering the order with the order issue. Alternatively, in this example, if fewer than the threshold number of items included in the order are associated with an expected cost that is at least the threshold cost, the issue prevention module 225 may determine not to invoke any preventative measures.

In some embodiments, the issue prevention module 225 generates a composite value associated with an order based on an expected cost associated with multiple items included in the order and determines whether to invoke a set of preventative measures to avoid delivering the order with an order issue based on the composite value. In such embodiments, the composite value may correspond to an average of the expected costs, a sum of the expected costs, or any other suitable type of composite value. For example, the issue prevention module 225 may generate a composite value associated with an order corresponding to a sum or an average of the expected costs predicted or computed for items included in the order and compare the composite value to a threshold value. In this example, if the composite value is at least the threshold value, the issue prevention module 225 may determine to invoke one or more preventative measures to avoid delivering the order with an order issue. Alternatively, in this example, if the composite value is less than the threshold value, the issue prevention module 225 may determine not to invoke any preventative measures.

In embodiments in which the issue prevention module 225 determines to invoke a set of preventative measures to avoid delivering an order with an order issue, the issue prevention module 225 may select the set of preventative measures from one or more preventative measures stored in the data store 240. The issue prevention module 225 may select the set of preventative measures based on the order issue, an expected cost associated with one or more items included in the order, a cost associated with each preventative measure, or any other suitable types of information. For example, if the issue prevention module 225 has determined to invoke a set of preventative measures to avoid delivering an order with an order issue corresponding to a missing item, the issue prevention module 225 may select preventative measures associated with the order issue and compare an expected cost associated with each item included in the order to a cost associated with each preventative measure. Continuing with this example, the issue prevention module 225 may then select one or more preventative measures associated with costs that are less than or equal to the highest expected cost. In various embodiments, the issue prevention module 225 selects the set of preventative measures based on a composite value associated with the order and a cost associated with each preventative measure. In the above example, the issue prevention module 225 alternatively may compare a composite value generated based on the expected costs associated with the items included in the order (e.g., a sum of the expected costs) to the cost associated with each preventative measure and select one or more preventative measures associated with costs that are less than or equal to the composite value.

In some embodiments, the issue prevention module 225 selects a set of preventative measures to avoid delivering an order with an order issue based on a preventative measure score. The issue prevention module 225 predicts for each preventative measure that may be invoked. The preventative measure score indicates an effectiveness of the preventative measure and may correspond to a value (e.g., from zero to one) that is proportional to its effectiveness. The issue prevention module 225 may predict the preventative measure score for a preventative measure based on a set of order data for each of one or more orders being serviced by a picker, a set of item data for each item included in an order, a set of preventative measure data for the preventative measure, or any other suitable types of data it may retrieve from the data store 240. Once the issue prevention module 225 predicts the preventative measure score for each preventative measure that may be invoked to avoid delivering the order with the order issue, the issue prevention module 225 selects the set of preventative measures to invoke based on the preventative measure scores. For example, the issue prevention module 225 may select one or more preventative measures associated with at least a threshold preventative measure score or a preventative measure associated with a highest preventative measure score.

The following illustrate examples of how the issue prevention module 225 may predict a preventative measure score for a preventative measure that may be invoked to avoid delivering an order with an order issue. A set of order data for an order may indicate a number of items included in the order that are round or cylindrical or less than a threshold size or weight. In this example, the issue prevention module 225 may predict a preventative measure score for a preventative measure corresponding to scanning a machine-readable label (e.g., a barcode or a QR code) coupled to each item that encodes an item identifier for the item. Continuing with this example, since smaller and lighter items are more likely to be overlooked, forgotten, or misplaced by a picker servicing the order than larger, heavier items, the preventative measure score may be proportional to a number of items included in the order that are less than the threshold size or weight. Alternatively, in the above example, the preventative measure may correspond to organizing the items in a way to prevent them from rolling or falling out of a bag. In this example, since round or cylindrical items are more likely to roll out of a bag than items of other shapes, the preventative measure score may be proportional to a number of items included in the order that are round or cylindrical. As an additional example, t a set of order data for each of multiple orders being serviced by a picker may describe a source location from which items included in each order were collected. In this example, the issue prevention module 225 may predict a preventative measure score for a preventative measure corresponding to organizing the items in bags to indicate whether they are included in the same order. Continuing with this example, since bags of items collected from the same source location are more likely to look similar to each other than bags of items collected from different source locations, the preventative measure score may be proportional to a number of orders including items collected from the same source location.

In some embodiments, the issue prevention module 225 predicts a preventative measure score for a preventative measure using a preventative measure prediction model, which is a machine learning model trained to do so. To use the preventative measure prediction model, the issue prevention module 225 may access the model (e.g., from the data store 240) and apply the model to a set of inputs. The set of inputs may include various types of data the issue prevention module 225 may retrieve from the data store 240 described above (e.g., a set of order data for each of one or more orders being serviced by a picker, a set of item data for each item included in an order, a set of preventative measure data for a preventative measure, etc.). Once the issue prevention module 225 applies the preventative measure prediction model to the set of inputs, the issue prevention module 225 may receive an output from the model, which may include a value corresponding to a preventative measure score for a preventative measure. In some embodiments, the preventative measure prediction model is trained by the machine-learning training module 230, as described below.

In some embodiments, the issue prevention module 225 selects one or more items included in an order based on a value of an order issue metric associated with each item included in the order. For example, the issue prevention module 225 may compare a value of an order issue metric associated with an item to a threshold value, in which the value corresponds to a probability that the item is associated with an order issue and that the user will raise the order issue. In the above example, if the value is at least the threshold value, the issue prevention module 225 may select the item. Once the issue prevention module 225 selects the items, the communication module 223 may send a prompt to a user client device 100 associated with a user who placed the order for a response indicating whether the items is/are associated with an order issue, as described above.

The scoring module 226 may generate a picker quality score indicating a quality of a picker. As described above, the picker quality score may be normalized to account for differences between orders serviced by the picker, such as different rates at which different users raise order issues, order complexity (e.g., a number of items included in each order or whether each order includes instructions specified by a user), etc. The scoring module 226 may generate the picker quality score based on information it retrieves from the data store 240, such as an expected cost associated with each item included in each order serviced by the picker, an actual cost associated with each item included in each order serviced by the picker, or any other suitable types of information. For example, the scoring module 226 may retrieve information from the data store 240 describing an expected cost associated with each item included in each order serviced by a picker and an actual cost associated with the item. In this example, the scoring module 226 may compute a first average of the expected costs and a second average of the actual costs, compare the first average with the second average, and generate a picker quality score for the picker based on the comparison. In the above example, the picker quality score may be proportional to a difference between the first average and the second average. In the above example, the picker quality score may be negative if the second average of the actual costs is greater than the first average of the expected costs. Alternatively, in the above example, the picker quality score may be positive if the second average of the actual costs is less than the first average of the expected costs.

The compensation module 227 coordinates payment by the user for the order. The compensation module 227 uses payment information provided by the user (e.g., a credit card number or a bank account) to receive payment for the order. In some embodiments, the compensation module 227 stores the payment information for use in subsequent orders by the user. The compensation module 227 computes the total cost for the order and charges the user that cost. The compensation module 227 may provide a portion of the total cost to the picker for servicing the order, and another portion of the total cost to the source.

In some embodiments, the compensation module 227 computes an actual cost (e.g., a dollar amount or a null value) associated with an item included in an order. The compensation module 227 may compute the actual cost based on a type of appeasement provided to a user who placed the order due to an order issue associated with the item, if any. For example, if an item included in an order is not associated with an order issue, an actual cost associated with the item may be a null value. Alternatively, in the above example, if the item is associated with an order issue corresponding to a missing item, the actual cost associated with the item may be a dollar amount that the online system 140 must forfeit to appease the user. Examples of types of appeasements include: a refund for the item, a credit, discount or voucher that may be applied to a subsequent purchase, a replacement for the item (e.g., with the same item or a similar item), or any other suitable types of appeasements. For example, a user may raise an order issue for an order, in which the order issue corresponds to a missing item. In this example, the compensation module 227 may compute an actual cost associated with the missing item corresponding to an amount of a refund for the item. Alternatively, in this example, the user may request a replacement for the missing item. In this example, the actual cost may correspond to a sum of: a cost associated with the replacement (e.g., a price of the replacement) and a cost associated with diverting time and resources to replace the missing item (e.g., opportunity cost, payment to a picker for collecting and delivering the replacement, etc.). Once the compensation module 227 computes the actual cost, the compensation module 227 may store it in the data store 240 in association with various types of information (e.g., item data for the item, order data for the order, user data for the user, picker data for a picker who serviced the order, etc.).

The machine-learning training module 230 trains machine learning models used by the online system 140. The online system 140 may use machine learning models to perform functionalities described herein. Example machine learning models include regression models, support vector machines, naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, transformers, large language models, or multi-modal large language models. A machine learning model may include components relating to these different general categories of model, which may be sequenced, layered, or otherwise combined in various configurations. While the term “machine learning model” may be broadly used herein to refer to any kind of machine learning model, the term is generally limited to those types of models that are suitable for performing the described functionality. For example, certain types of machine learning models can perform a particular functionality based on the intended inputs to, and outputs from, the model, the capabilities of the system on which the machine learning model will operate, or the type and availability of training data for the model.

Each machine learning model includes a set of parameters. The set of parameters for a machine learning model is used by the machine learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine learning model by “training” the machine learning model. Once trained, the machine learning model uses the set of parameters to transform inputs into outputs.

The machine-learning training module 230 trains a machine learning model based on a set of training examples. Each training example includes input data to which the machine learning model is applied to generate an output. For example, each training example may include user data, picker data, item data, order data, or preventative measure data. In some cases, the training examples also include a label which represents an expected output of the machine learning model. In these cases, the machine learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

In embodiments in which the prediction module 224 accesses and applies the order issue metric prediction model to predict a value of an order issue metric associated with an item included in an order if the item is associated with an order issue, the machine-learning training module 230 may train the order issue metric prediction model. The machine-learning training module 230 may do so via supervised learning or using any other suitable technique or combination of techniques based on data stored in the data store 240 or any other suitable types of data. Furthermore, once trained, the machine-learning training module 230 may retrain the order issue metric prediction model. For example, to refine predictions made by the order issue metric prediction model, the training dataset used to retrain the order issue metric prediction model may be updated regularly as order data is updated to include information describing an actual value of an order issue metric associated with each item included in each order delivered to a user of the online system 140. In this example, the actual value may indicate whether an item included in an order was associated with the order issue and whether a user who placed the order raised the order issue. Alternatively, in this example, if the item was associated with the order issue and the user raised the order issue, the actual value may be an actual cost associated with the item assumed by the online system 140 to appease the user.

To illustrate an example of how the machine-learning training module 230 may train the order issue metric prediction model, the machine-learning training module 230 may receive a set of training examples. In this example, the set of training examples may include attributes of users, such as information describing orders previously placed by each user (e.g., whether the user raised an order issue for each order), demographic or household information associated with each user, etc. Continuing with this example, the set of training examples further may include attributes of each order placed by each user (e.g., a number of items included in the order, information identifying the items and a source location from which the items were collected, a tendency of items collected from the source location to be associated with a type of order issue, etc.). In this example, the set of training examples also may include attributes of each item included in each order (e.g., a price, size, shape, etc. of the item, a frequency with which the item is associated with a type of order issue, etc.). In the above example, the set of training examples also may include attributes of pickers who serviced the orders, such as information describing orders serviced by each picker (e.g., whether an order issue was raised for each order), demographic information associated with each picker, etc. In this example, the set of training examples also may include a label describing, for each item included in each order, an actual cost associated with the item assumed by the online system 140 to appease a user. Alternatively, the label may describe, for each item included in each order, whether the item was missing when delivered and a user indicated that the item was missing. Continuing with this example, the machine-learning training module 230 may then update a set of parameters of the order issue metric prediction model based on the sets of attributes, as well as the labels by comparing its output from input data of each training example to the label for the training example.

In embodiments in which the issue prevention module 225 accesses and applies the preventative measure prediction model to predict a preventative measure score for a preventative measure, the machine-learning training module 230 may train the preventative measure prediction model. The machine-learning training module 230 may do so via supervised learning or using any other suitable technique or combination of techniques based on data stored in the data store 240 or any other suitable types of data. Furthermore, once trained, the machine-learning training module 230 may retrain the preventative measure prediction model. For example, to refine predictions made by the preventative measure prediction model, the training dataset used to retrain the preventative measure prediction model may be updated regularly as order data is updated to include information describing whether a preventative measure invoked to prevent an order issue associated with an item included in an order was effective at preventing the order issue.

To illustrate an example of how the machine-learning training module 230 may train the preventative measure prediction model, the machine-learning training module 230 may receive a set of training examples. In this example, the set of training examples may include attributes of each order placed by a user (e.g., a number of items included in the order, a source location from which items included in the order were collected, a set of preventative measures invoked to avoid an order issue, etc.). In the above example, the set of training examples also may include attributes of each item included in each order (e.g., a price, size, weight, shape, etc. of the item). In this example, for each preventative measure invoked to avoid an order issue, the set of training examples also may include a label which represents an expected output of the preventative measure prediction model. In the above example, the label may describe whether the preventative measure was effective at preventing the order issue (e.g., whether an item included in an order was associated with the order issue and a user who placed the order raised the order issue). Continuing with this example, the machine-learning training module 230 may then update a set of parameters of the preventative measure prediction model based on the sets of attributes, as well as the labels by comparing its output from input data of each training example to the label for the training example.

The machine-learning training module 230 may apply an iterative process to train a machine learning model whereby the machine-learning training module 230 updates parameter values of the machine learning model based on each of the set of training examples. The training examples may be processed together, individually, or in batches. To train a machine learning model based on a training example, the machine-learning training module 230 applies the machine learning model to the input data in the training example to generate an output based on a current set of parameter values. The machine-learning training module 230 scores the output from the machine learning model using a loss function. A loss function is a function that generates a score for the output of the machine learning model such that the score is higher when the machine learning model performs poorly and lower when the machine learning model performs well. In cases in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine learning model based on the score generated by the loss function. For example, the machine-learning training module 230 may apply gradient descent to update the set of parameters.

In some embodiments, the machine-learning training module 230 may retrain the machine learning model based on the actual performance of the model after the online system 140 has deployed the model to provide service to users. For example, if the machine learning model is used to predict a likelihood of an outcome of an event, the online system 140 may log the prediction and an observation of the actual outcome of the event. Alternatively, if the machine learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine learning model using the additional training data, using any of the methods described above. This deployment and retraining process may be repeated over the lifetime use for the machine learning model. This way, the machine learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, preventative measure data, and picker data for use by the online system 140. The data store 240 also stores trained machine learning models trained by the machine-learning training module 230. For example, the data store 240 may store the set of parameters for a trained machine learning model on one or more non-transitory, computer-readable media. The data store 240 uses computer-readable media to store data, and may use databases to organize the stored data.

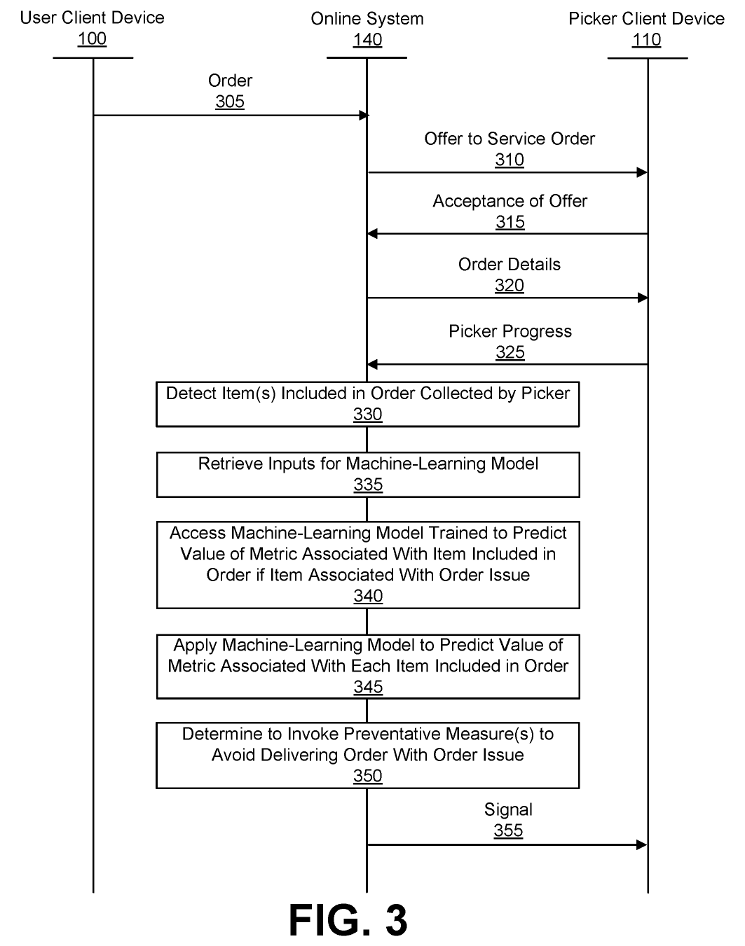

FIG. 3 is a flowchart for a method of determining to invoke a set of preventative measures to avoid delivering an order with a missing item, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives 305 (e.g., via the offering module 221), an order including one or more items from a user client device 100 associated with a user of the online system 140 and sends 310 (e.g., via the offering module 221) an offer to service the order to a picker via a picker client device 110 associated with the picker. Once the online system 140 receives 315 (e.g., via the offering module 221) an acceptance of the offer to service the order from the picker client device 110, the online system 140 sends 320 (e.g., via the servicing module 222) details about the order (e.g., information describing a number of items included in the order, information identifying the items, information identifying a source location from which the items are to be collected, etc.) to the picker client device 110. The online system 140 then tracks 325 (e.g., via the servicing module 222) the progress of the picker as the picker collects the items included in the order.

Once the online system 140 detects 330 (e.g., via the servicing module 222) that the picker has collected the items included in the order, the online system 140 retrieves 335 (e.g., via the prediction module 224) various types of data (e.g., from the data store 240). Examples of types of data the online system 140 may retrieve 335 include: a set of picker data for the picker, a set of user data for the user, a set of order data for the order, a set of item data for the items included in the order, or any other suitable types of information. In some embodiments, one or more sets of data retrieved 335 by the online system 140 are included among a set of inputs for a machine learning model, as further described below. The set of picker data retrieved 335 by the online system 140 may indicate a skill level associated with the picker, such as information describing a user rating for the picker and the picker’s previous shopping history (e.g., a number of orders or batches of orders the picker has serviced). The set of user data retrieved 335 by the online system 140 may indicate a tendency of the user to raise an order issue, such as information describing a frequency with which the user indicates items are missing from their orders when delivered (e.g., either because an item was not collected or an incorrect version/variety of an item was collected). The set of order data retrieved 335 by the online system 140 may describe the items included in the order, a source from which the items was/were ordered, a source location from which the items was/were collected, or a tendency of items ordered from the source or collected from the source location to be associated with a type of order issue. The set of item data retrieved 335 by the online system 140 may include information describing a tendency of an item included in the order to be associated with a type of order issue or attributes of the item, such as information describing a size, weight, shape, or price of the item.

The online system 140 may then predict 345 (e.g., using the prediction module 224) a value of an order issue metric associated with each item included in the order if the item is associated with an order issue (e.g., a missing, mishandled, or damaged item, failure to follow instructions for collecting an item, etc.). In some embodiments, the order issue metric is an expected cost (e.g., a dollar amount) assumed by the online system 140 to appease the user. In such embodiments, the expected cost may be based on a probability that the item is associated with the order issue and that the user will raise the order issue, as well as an appeasement cost associated with an appeasement offered to the user due to the order issue. The appeasement cost may be a cost of the item (e.g., a price of the item if a refund or a credit is issued for the item), a cost of replacing the item (e.g., a sum of a price of a replacement for the item and an amount paid to a picker to collect and deliver it), or any other suitable cost associated with the appeasement. In other embodiments, the order issue metric is a probability that the item is associated with the order issue and that the user will raise the order issue. In such embodiments, the online system 140 may compute (e.g., using the prediction module 224) the expected cost assumed by the online system 140 to appease the user based on the probability and the appeasement cost (e.g., as a product of the probability and the appeasement cost). The expected cost also may be based on a long-term value associated with the user, a probability that the user stops placing orders with the online system 140 if the item is associated with the order issue, or any other suitable types of information. The online system 140 may predict the value of the order issue metric based on the data it retrieves 335 or based on any other suitable types of data. Once the online system 140 predicts the value of the order issue metric, it may store (e.g., using the prediction module 224) the value (e.g., in the data store 240 in association with item data for the item, order data for the order, user data for the user, picker data for the picker, etc.).

In some embodiments, the online system 140 predicts a value of the order issue metric associated with an item included in the order if the item is associated with the order issue using an order issue metric prediction model, which is a machine learning model trained to predict the value. To use the order issue metric prediction model, the online system 140 may access 340 (e.g., using the prediction module 224) the model (e.g., from the data store 240) and apply 345 (e.g., using the prediction module 224) the model to a set of inputs. The set of inputs may include various types of data retrieved 335 by the online system 140 described above (e.g., a set of picker data for the picker, a set of user data for the user, a set of order data for the order, a set of item data for the item, etc.). Once the online system 140 applies 345 the order issue metric prediction model to the set of inputs, the online system 140 may receive (e.g., via the prediction module 224) an output from the model, which may include the value of the order issue metric associated with the item included in the order if the item is associated with the order issue. In some embodiments, the order issue metric prediction model is trained by the online system 140 (e.g., using the machine-learning training module 230).

The online system 140 then determines 350 (e.g., using the issue prevention module 225) whether to invoke a set of preventative measures to avoid delivering the order with the order issue. Examples of such measures include: scanning a machine-readable label (e.g., a barcode or a QR code) coupled to an item that encodes an item identifier for the item or capturing an image or a video of an item and identifying an item identifier for the item based on the image/video (e.g., using a picker client device 110 or by transmitting the image/video to the online system 140). Additional examples of preventative measures include: organizing one or more items (e.g., in bags or other containers to indicate whether they are included in the same order or to prevent the items from rolling or falling out of the bags/containers), capturing an image/video of the organized items, and transmitting the image/video to the online system 140. The online system 140 may determine 350 whether to invoke the set of preventative measures based on an expected cost assumed by the online system 140 to appease the user (e.g., whether the expected cost is at least a threshold cost).

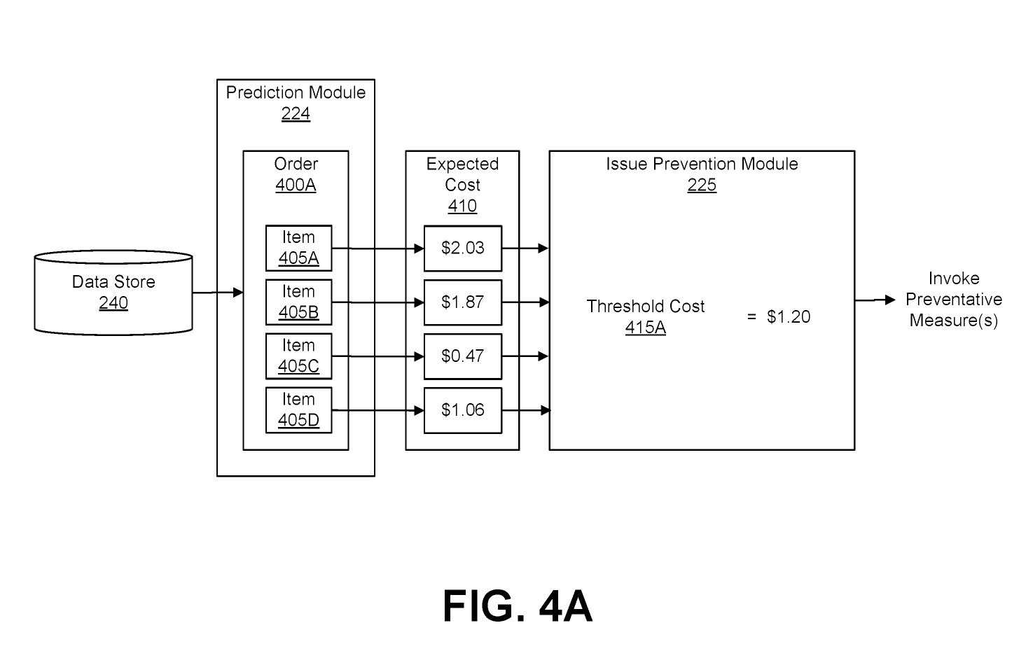

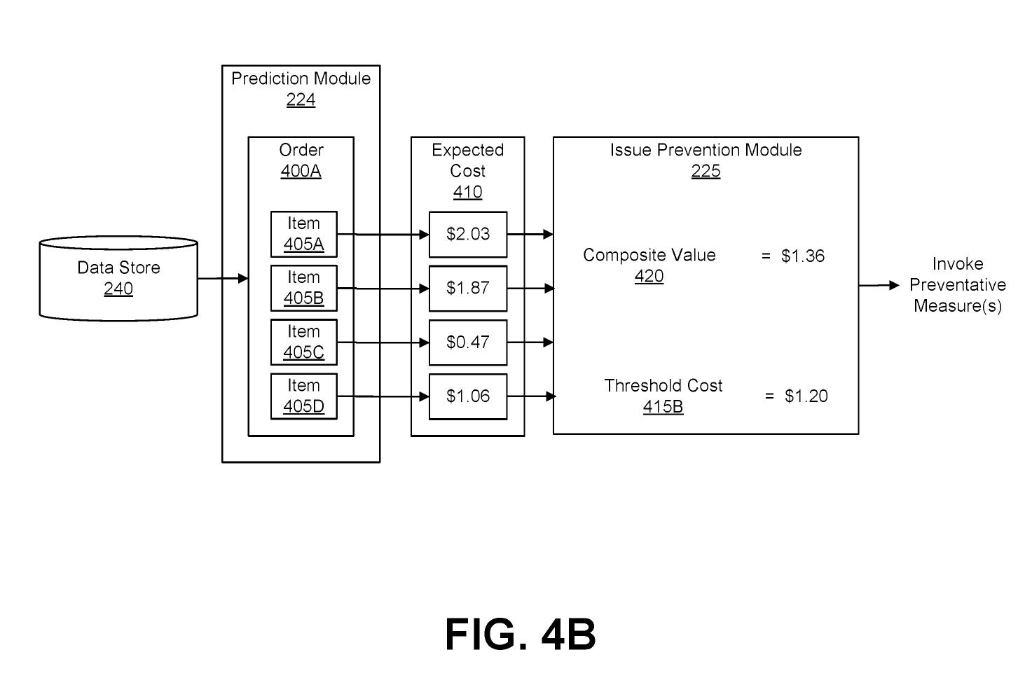

FIG. 4A illustrates an example process for determining to invoke a set of preventative measures to avoid delivering an order 400A with a missing item 405 based on a predicted value of a metric associated with each item 405A–D included in the order 400A, in accordance with one or more embodiments. As shown in the example of FIG. 4A, for each item 405A–D included in the order 400A, the online system 140 may predict or compute an expected cost 410 assumed by the online system 140 to appease the user if the item 405A–D is associated with the order issue and compares each expected cost 410 to a threshold cost 415A. In this example, if at least two items 405A–D included in the order 400A are associated with an expected cost 410 that is at least the threshold cost 415A of $1.20, the online system 140 may determine 350 to invoke one or more preventative measures to avoid delivering the order 400A with a missing item 405. In this example, since item 405A and item 405B are associated with expected costs 410 of $2.03 and $1.87, respectively, the online system 140 may determine 350 to invoke the preventative measures. Alternatively, although not shown in FIG. 4A, in this example, if fewer than two items 405A–D included in the order 400A are associated with an expected cost 410 that is at least the threshold cost 415A, the online system 140 may determine 350 not to invoke any preventative measures.

In embodiments in which the order 400 includes multiple items 405, the online system 140 may generate (e.g., using the issue prevention module 225) a composite value associated with the order 400 based on the expected costs 410 associated with the items 405. In such embodiments, the composite value may correspond to an average of the expected costs 410, a sum of the expected costs 410, or any other suitable type of composite value. The online system 140 may then determine 350 whether to invoke the set of preventative measures based on the composite value.

FIG. 4B illustrates an example process for determining to invoke a set of preventative measures to avoid delivering an order 400A with a missing item 405 based on a composite value 420 associated with items 405A–D included in the order 400A, in accordance with one or more embodiments. As shown in the example of FIG. 4B, which continues the example described above in conjunction with FIG. 4A, the online system 140 also or alternatively may generate a composite value 420 associated with the order 400A corresponding to a sum or an average of the expected costs 410 predicted or computed for the items 405A–D included in the order 400A. In the above example, the online system 140 may then compare (e.g., using the issue prevention module 225) the composite value 420 to an additional threshold cost 415B. In this example, since the composite value 420 of $1.36 is at least the additional threshold cost 415B of $1.20, the online system 140 may determine 350 to invoke one or more preventative measures to avoid delivering the order 400A with a missing item 405. Alternatively, although not shown in FIG. 4B, in this example, if the composite value 420 is less than the threshold cost 415B, the online system 140 may determine 350 not to invoke any preventative measures.

In embodiments in which the online system 140 determines 350 to invoke the set of preventative measures, the online system 140 may select (e.g., using the issue prevention module 225) the set of preventative measures from one or more preventative measures (e.g., stored in the data store 240). The online system 140 may select the set of preventative measures based on the order issue, an expected cost 410 associated with one or more items 405 included in the order 400, a cost associated with each preventative measure, or any other suitable types of information (e.g., by selecting one or more preventative measures associated with costs that are less than or equal to the highest expected cost 410). In various embodiments, the online system 140 selects the set of preventative measures based on a composite value 420 associated with the order 400 and a cost associated with each preventative measure (e.g., by selecting one or more preventative measures associated with costs that are less than or equal to the composite value 420).

In some embodiments, the online system 140 selects the set of preventative measures based on a preventative measure score the online system 140 predicts (e.g., using the issue prevention module 225) for each preventative measure that may be invoked. The preventative measure score indicates an effectiveness of the preventative measure and may correspond to a value (e.g., from zero to one) that is proportional to its effectiveness. The online system 140 may predict the preventative measure score for a preventative measure based on a set of order data for each of one or more orders 400 being serviced by the picker, a set of item data for each item 405 included in the order 400, a set of preventative measure data for the preventative measure, or any other suitable types of data it may retrieve (e.g., from the data store 240 using the issue prevention module 225). Once the online system 140 predicts the preventative measure score for each preventative measure that may be invoked to avoid delivering the order 400 with the order issue, the online system 140 selects the set of preventative measures to invoke based on the preventative measure scores.

In some embodiments, the online system 140 predicts a preventative measure score for a preventative measure using a preventative measure prediction model, which is a machine learning model trained to do so. To use the preventative measure prediction model, the online system 140 may access (e.g., using the issue prevention module 225) the model (e.g., from the data store 240) and apply (e.g., using the issue prevention module 225) the model to a set of inputs. The set of inputs may include various types of data (e.g., a set of order data for each of one or more orders 400 being serviced by the picker, a set of item data for each item 405 included in the order 400, a set of preventative measure data for a preventative measure, etc.) that the online system 140 may retrieve (e.g., from the data store 240), as described above. Once the online system 140 applies the preventative measure prediction model to the set of inputs, the online system 140 may receive (e.g., via the issue prevention module 225) an output from the model, which may include a value corresponding to a preventative measure score for a preventative measure. In some embodiments, the preventative measure prediction model is trained by the online system 140 (e.g., using the machine-learning training module 230).

Referring back to FIG. 3, the online system 140 may then send 355 (e.g., using the communication module 223) a signal to the picker client device 110 associated with the picker, causing the picker client device 110 to display information describing the set of preventative measures to avoid delivering the order 400 with the order issue. The online system 140 may send 355 the signal via a push notification, a text message, an email, or any other suitable means.

In some embodiments, the online system 140 selects (e.g., using the issue prevention module 225) one or more items 405 included in the order 400 based on a value of the order issue metric associated with each item 405 included in the order 400 (e.g., whether the value is at least a threshold value). The online system 140 may then send (e.g., using the communication module 223) a prompt to the user client device 100 for a response indicating whether the identified items 405 is/are associated with the order issue. The online system 140 may send the prompt via a push notification, a text message, an email, or any other suitable means. The online system 140 may do so once it detects (e.g., using the servicing module 222) that the order 400 has been delivered to the user.

Additionally, the online system 140 may receive (e.g., via the communication module 223) information describing an order issue raised by the user. The online system 140 may receive the information from the user client device 100 associated with the user. Once the online system 140 receives the information describing the order issue, the online system 140 may store (e.g., using the communication module 223) the information (e.g., in the data store 240 in association with order data for the order 400, item data for an item 405 associated with the order issue, user data for the user, picker data for the picker, etc.).

In some embodiments, the online system 140 computes (e.g., using the compensation module 227) an actual cost (e.g., a dollar amount or a null value) associated with an item 405 included in the order 400. The online system 140 may compute the actual cost based on a type of appeasement provided to the user who placed the order 400 due to an order issue associated with the item 405, if any. Examples of types of appeasements include: a refund for the item 405, a credit, discount or voucher that may be applied to a subsequent purchase, a replacement for the item 405 (e.g., with the same item 405 or a similar item 405), or any other suitable types of appeasements. Once the online system 140 computes the actual cost, the online system 140 may store it (e.g., in the data store 240 in association with item data for the item 405, order data for the order 400, user data for the user, picker data for the picker, etc.).

The online system 140 also may generate (e.g., using the scoring module 226) a fulfillment reliability score indicating a reliability of order fulfillment by the picker. The fulfillment reliability score may be normalized to account for differences between orders 400 serviced by the picker, such as different rates at which different users raise order issues, order complexity (e.g., a number of items 405 included in each order 400 or whether each order 400 includes instructions specified by a user), etc. The online system 140 may generate the fulfillment reliability score based on information it retrieves (e.g., from the data store 240 using the scoring module 226), such as an expected cost 410 associated with each item 405 included in each order 400 serviced by the picker, an actual cost associated with each item 405 included in each order 400 serviced by the picker, or any other suitable types of information. The fulfillment reliability score may be used for various purposes, such as providing benefits (e.g., priority access to orders) to pickers with higher fulfillment reliability scores, offering more complicated orders to pickers with higher fulfillment reliability scores, etc.

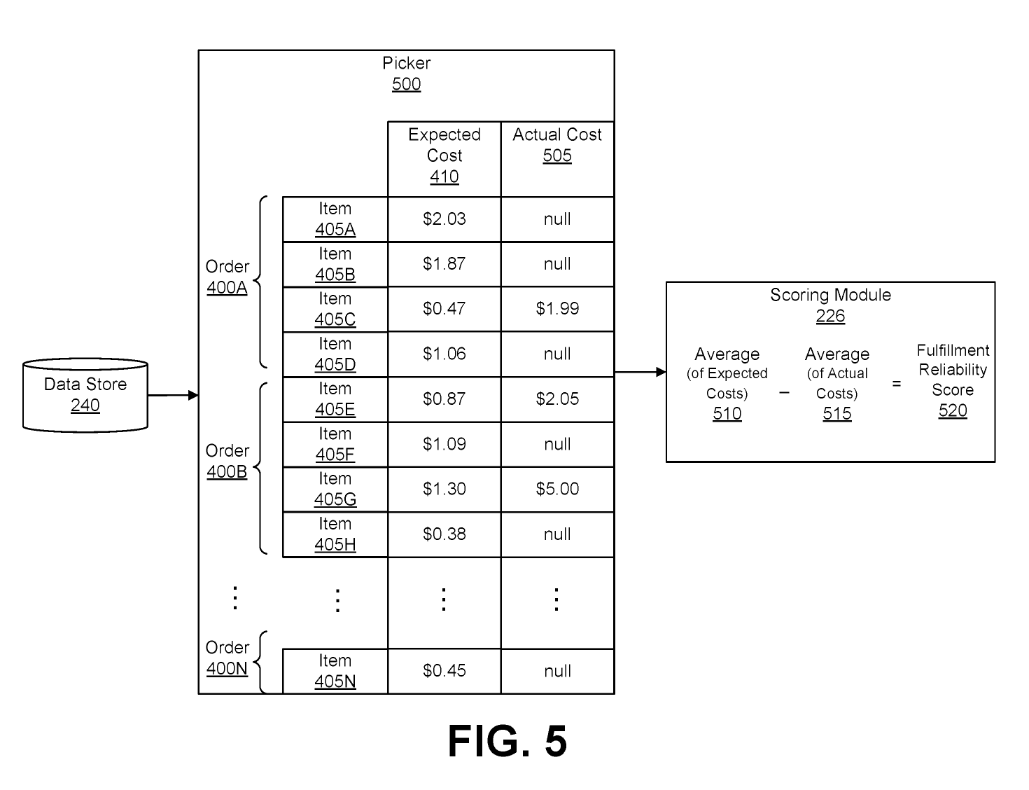

FIG. 5 illustrates an example process for generating a fulfillment reliability score 520 associated with a picker 500, in accordance with one or more embodiments. As shown in the example of FIG. 5, the online system 140 may retrieve information (e.g., from the data store 240) describing an expected cost 410 associated with each item 405A–N included in each order 400A–N serviced by the picker 500 and an actual cost 505 associated with the item 405A–N. In this example, the online system 140 may compute (e.g., using the scoring module 226) a first average 510 of the expected costs 410 and a second average 515 of the actual costs 505, compare (e.g., using the scoring module 226) the first average 510 with the second average 515, and generate a fulfillment reliability score 520 for the picker 500 based on the comparison. In the above example, the fulfillment reliability score 520 may be proportional to a difference between the first average 510 and the second average 515. In the above example, the fulfillment reliability score 520 may be negative if the second average 515 of the actual costs 505 is greater than the first average 510 of the expected costs 410. Alternatively, in the above example, the fulfillment reliability score 520 may be positive if the second average 515 of the actual costs 505 is less than the first average 510 of the expected costs 410.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, from a user client device associated with a user of an online system, an order comprising one or more items;
detecting that a picker servicing the order has collected the one or more items from a source location;
retrieving a set of inputs for a machine learning model trained to predict a value of a metric associated with an item included in the order if the item is missing when the order is delivered to the user, wherein the set of inputs comprises a set of picker data indicating a skill level associated with the picker, a set of user data indicating a tendency of the user to raise an order issue, and a set of item data for each item of the one or more items;
accessing the machine learning model, wherein the machine learning model is trained by:
gathering a set of training examples, each training example of the set of training examples comprising information describing each user of a plurality of users who placed one or more orders, each picker of a plurality of pickers who serviced the one or more orders, each item included in each order of the one or more orders, and, for each order of the one or more orders, the value of the metric associated with each missing item of a set of missing items associated with a corresponding order when delivered to a corresponding user, and
updating a set of parameters of the machine learning model based at least in part on the set of training examples;
for each item of the one or more items included in the order, applying the machine learning model to predict, based at least in part on the set of inputs, the value of the metric associated with a corresponding item if the corresponding item is missing when the order is delivered to the user;
determining to invoke a set of preventative measures to avoid delivering the order with one or more missing items based at least in part on the predicted value of the metric associated with each item of the one or more items included in the order; and
sending a signal to a picker client device associated with the picker, causing the picker client device to display information describing the set of preventative measures.

2. The method of claim 1, wherein, for each item of the one or more items included in the order, applying the machine learning model to predict, based at least in part on the set of inputs, the value of the metric associated with the corresponding item if the corresponding item is missing when the order is delivered to the user comprises:
for each item of the one or more items included in the order, applying the machine learning model to predict, based at least in part on the set of inputs, the value of the metric associated with the corresponding item if the corresponding item is missing when the order is delivered to the user, wherein the value of the metric comprises an expected cost associated with the corresponding item assumed by the online system.

3. The method of claim 1, wherein, for each item of the one or more items included in the order, applying the machine learning model to predict, based at least in part on the set of inputs, the value of the metric associated with the corresponding item if the corresponding item is missing when the order is delivered to the user comprises:
for each item of the one or more items included in the order, applying the machine learning model to predict, based at least in part on the set of inputs, the value of the metric associated with the corresponding item if the corresponding item is missing when the order is delivered to the user, wherein the value of the metric comprises a probability that the corresponding item is missing when the order is delivered to the user and that the user will indicate that the corresponding item is missing.

4. The method of claim 3, wherein determining to invoke the set of preventative measures to avoid delivering the order with the one or more missing items based at least in part on the predicted value of the metric associated with each item of the one or more items included in the order comprises:
for each item of the one or more items included in the order, generating an expected cost associated with the corresponding item if the corresponding item is missing when the order is delivered to the user based at least in part on a cost associated with an appeasement provided to the user and the probability that the corresponding item is missing when the order is delivered to the user and that the user will indicate that the corresponding item is missing; and
determining whether to invoke the set of preventative measures to avoid delivering the order with the one or more missing items based at least in part on the expected cost associated with each item of the one or more items included in the order.

5. The method of claim 1, further comprising:
selecting, from one or more preventative measures, the set of preventative measures to avoid delivering the order with the one or more missing items based at least in part on the predicted value of the metric associated with each item of the one or more items included in the order.

6. The method of claim 5, wherein selecting, from the one or more preventative measures, the set of preventative measures to avoid delivering the order with the one or more missing items based at least in part on the predicted value of the metric associated with each item of the one or more items included in the order comprises:
selecting the set of preventative measures from one or more of: scanning a machine-readable label coupled to each item of the one or more items included in the order, capturing an image of each item of the one or more items included in the order, capturing a video of each item of the one or more items included in the order, or organizing the one or more items included in the order.

7. The method of claim 1, wherein retrieving the set of inputs for the machine learning model trained to predict the value of the metric associated with the item included in the order if the item is missing when the order is delivered to the user comprises:
retrieving information describing one or more of: historical order information associated with the picker, demographic information associated with the picker, historical order information associated with the user, demographic information associated with the user, historical order information associated with each item of the one or more items, a size of each item of the one or more items, a weight of each item of the one or more items, a shape of each item of the one or more items, or a price of each item of the one or more items.

8. The method of claim 1, further comprising:
generating a fulfillment reliability score indicating a reliability of order fulfillment by the picker based at least in part on the predicted value of the metric associated with each item of the one or more items included in the order.

9. The method of claim 1, wherein determining to invoke the set of preventative measures to avoid delivering the order with the one or more missing items based at least in part on the predicted value of the metric associated with each item of the one or more items included in the order comprises:
generating a composite value based at least in part on the predicted value of the metric associated with each item of the one or more items included in the order, wherein the composite value comprises one or more of a sum or an average;
comparing one or more of the composite value or the predicted value of the metric associated with each item of the one or more items included in the order to a threshold value; and
determining to invoke the set of preventative measures to avoid delivering the order with the one or more missing items based at least in part on the comparing.

10. The method of claim 1, further comprising:
receiving information describing a set of missing items when the order was delivered to the user;
computing an actual value of the metric associated with each missing item included in the order based at least in part on an appeasement provided to the user; and
retraining the machine learning model based at least in part on the actual value of the metric associated with each missing item included in the order.

11. A computer program product comprising a non-transitory computer-readable storage medium having instructions encoded thereon that, when executed by a processor, cause the processor to perform steps comprising:
receiving, from a user client device associated with a user of an online system, an order comprising one or more items;
detecting that a picker servicing the order has collected the one or more items from a source location;
retrieving a set of inputs for a machine learning model trained to predict a value of a metric associated with an item included in the order if the item is missing when the order is delivered to the user, wherein the set of inputs comprises a set of picker data indicating a skill level associated with the picker, a set of user data indicating a tendency of the user to raise an order issue, and a set of item data for each item of the one or more items;
accessing the machine learning model, wherein the machine learning model is trained by:
gathering a set of training examples, each training example of the set of training examples comprising information describing each user of a plurality of users who placed one or more orders, each picker of a plurality of pickers who serviced the one or more orders, each item included in each order of the one or more orders, and, for each order of the one or more orders, the value of the metric associated with each missing item of a set of missing items associated with a corresponding order when delivered to a corresponding user, and
updating a set of parameters of the machine learning model based at least in part on the set of training examples;
for each item of the one or more items included in the order, applying the machine learning model to predict, based at least in part on the set of inputs, the value of the metric associated with a corresponding item if the corresponding item is missing when the order is delivered to the user;
determining to invoke a set of preventative measures to avoid delivering the order with one or more missing items based at least in part on the predicted value of the metric associated with each item of the one or more items included in the order; and
sending a signal to a picker client device associated with the picker, causing the picker client device to display information describing the set of preventative measures.

12. The computer program product of claim 11, wherein, for each item of the one or more items included in the order, applying the machine learning model to predict, based at least in part on the set of inputs, the value of the metric associated with the corresponding item if the corresponding item is missing when the order is delivered to the user comprises:
for each item of the one or more items included in the order, applying the machine learning model to predict, based at least in part on the set of inputs, the value of the metric associated with the corresponding item if the corresponding item is missing when the order is delivered to the user, wherein the value of the metric comprises an expected cost associated with the corresponding item assumed by the online system.

13. The computer program product of claim 11, wherein, for each item of the one or more items included in the order, applying the machine learning model to predict, based at least in part on the set of inputs, the value of the metric associated with the corresponding item if the corresponding item is missing when the order is delivered to the user comprises:
for each item of the one or more items included in the order, applying the machine learning model to predict, based at least in part on the set of inputs, the value of the metric associated with the corresponding item if the corresponding item is missing when the order is delivered to the user, wherein the value of the metric comprises a probability that the corresponding item is missing when the order is delivered to the user and that the user will indicate that the corresponding item is missing.

14. The computer program product of claim 13, wherein determining to invoke the set of preventative measures to avoid delivering the order with the one or more missing items based at least in part on the predicted value of the metric associated with each item of the one or more items included in the order comprises:
for each item of the one or more items included in the order, generating an expected cost associated with the corresponding item if the corresponding item is missing when the order is delivered to the user based at least in part on a cost associated with an appeasement provided to the user and the probability that the corresponding item is missing when the order is delivered to the user and that the user will indicate that the corresponding item is missing; and
determining whether to invoke the set of preventative measures to avoid delivering the order with the one or more missing items based at least in part on the expected cost associated with each item of the one or more items included in the order.

15. The computer program product of claim 11, wherein the computer-readable storage medium further has instructions encoded thereon that, when executed by the processor, cause the processor to perform steps comprising:
selecting, from one or more preventative measures, the set of preventative measures to avoid delivering the order with the one or more missing items based at least in part on the predicted value of the metric associated with each item of the one or more items included in the order.

16. The computer program product of claim 15, wherein selecting, from the one or more preventative measures, the set of preventative measures to avoid delivering the order with the one or more missing items based at least in part on the predicted value of the metric associated with each item of the one or more items included in the order comprises:
selecting the set of preventative measures from one or more of: scanning a machine-readable label coupled to each item of the one or more items included in the order, capturing an image of each item of the one or more items included in the order, capturing a video of each item of the one or more items included in the order, or organizing the one or more items included in the order.

17. The computer program product of claim 11, wherein retrieving the set of inputs for the machine learning model trained to predict the value of the metric associated with the item included in the order if the item is missing when the order is delivered to the user comprises:
retrieving information describing one or more of: historical order information associated with the picker, demographic information associated with the picker, historical order information associated with the user, demographic information associated with the user, historical order information associated with each item of the one or more items, a size of each item of the one or more items, a weight of each item of the one or more items, a shape of each item of the one or more items, or a price of each item of the one or more items.

18. The computer program product of claim 11, wherein the computer-readable storage medium further has instructions encoded thereon that, when executed by the processor, cause the processor to perform steps comprising:
generating a fulfillment reliability score indicating a reliability of order fulfillment by the picker based at least in part on the predicted value of the metric associated with each item of the one or more items included in the order.

19. The computer program product of claim 11, wherein determining to invoke the set of preventative measures to avoid delivering the order with the one or more missing items based at least in part on the predicted value of the metric associated with each item of the one or more items included in the order comprises:
generating a composite value based at least in part on the predicted value of the metric associated with each item of the one or more items included in the order, wherein the composite value comprises one or more of a sum or an average;
comparing one or more of the composite value or the predicted value of the metric associated with each item of the one or more items included in the order to a threshold value; and
determining to invoke the set of preventative measures to avoid delivering the order with the one or more missing items based at least in part on the comparing.

20. A computer system comprising:
a processor; and
a non-transitory computer-readable storage medium storing instructions that, when executed by the processor, perform actions comprising:
receiving, from a user client device associated with a user of an online system, an order comprising one or more items;
detecting that a picker servicing the order has collected the one or more items from a source location;
retrieving a set of inputs for a machine learning model trained to predict a value of a metric associated with an item included in the order if the item is missing when the order is delivered to the user, wherein the set of inputs comprises a set of picker data indicating a skill level associated with the picker, a set of user data indicating a tendency of the user to raise an order issue, and a set of item data for each item of the one or more items;
accessing the machine learning model, wherein the machine learning model is trained by:
gathering a set of training examples, each training example of the set of training examples comprising information describing each user of a plurality of users who placed one or more orders, each picker of a plurality of pickers who serviced the one or more orders, each item included in each order of the one or more orders, and, for each order of the one or more orders, the value of the metric associated with each missing item of a set of missing items associated with a corresponding order when delivered to a corresponding user, and
updating a set of parameters of the machine learning model based at least in part on the set of training examples;
for each item of the one or more items included in the order, applying the machine learning model to predict, based at least in part on the set of inputs, the value of the metric associated with a corresponding item if the corresponding item is missing when the order is delivered to the user;
determining to invoke a set of preventative measures to avoid delivering the order with one or more missing items based at least in part on the predicted value of the metric associated with each item of the one or more items included in the order; and
sending a signal to a picker client device associated with the picker, causing the picker client device to display information describing the set of preventative measures.
